(19) United States
(12) Patent Application Publication
(10) Pub. No.: US 2022/0339979 A1
(43) Pub. Date: Oct. 27, 2022

(54) TRACTOR

(71) Applicant: KUBOTA CORPORATION, Osaka (JP)

(72) Inventors: Shinji Fujimoto, Sakai-shi (JP); Naoya Okamoto, Sakai-shi (JP)

(21) Appl. No.: 17/726,582

(22) Filed: Apr. 22, 2022

(30) Foreign Application Priority Data
Apr. 23, 2021 (JP) 2021-073413

(51) Int. Cl. B60D 1/14

(52) U.S. Cl. CPC B60D 1/141

(57) ABSTRACT

A tractor includes a body, a link mechanism including a link including an end on a side of the body, and a link attachment mechanism to attach the link to an end of the body in a front-back direction, the link attachment mechanism including a shaft with an axis in a left-right direction and supporting the end of the link such that the link is rotationally movable about the axis, at least one support located on the body and supporting the shaft, and a fixing tool to disable or enable movement of the shaft in the left-right direction relative to the at least one support and to allow the shaft to be pulled out of and inserted into the at least one support in the left-right direction.

### CROSS REFERENCE TO RELATED APPLICATION

This application is based on and claims priority under 35 U.S.C. Section 119 to Japanese Patent Application No. 2021-073413 filed on Apr. 23, 2021, the entire contents of which are incorporated herein by reference.

### BACKGROUND OF THE INVENTION

### 1. Field of the Invention

The present invention relates to a tractor including a detachable link mechanism at an end portion of a body in a front-back direction.

### 2. Description of the Related Art

A conventional tractor of the above type may include a rear coupling frame at a back portion of the body and a pair of left and right lower link pins at a lower portion of the rear coupling frame. The lower link pins each serve as a shaft for a lower link, and have respective ends facing each other in the axial direction and apart from each other by a predetermined distance. This structure allows each lower link to enter the space between the lower link pins and be fitted around the correspond lower link pin for attachment (see, for example, Japanese Unexamined Patent Application Publication, Tokukai, No. 2003-23808).

### SUMMARY OF THE INVENTION

The above conventional structure allows each lower link to be fitted around or pulled out from the corresponding lower link pin for attachment or detachment. This allows an additional device such as a backhoe to be attached or detached without difficulty with the entire link mechanism removed. The above structure may thus be advantageous in terms of increasing the versatility of a tractor.

With the above structure, however, bringing each lower link into the narrow space between the lower link pins and fitting the base portion of the lower link around the corresponding lower link pin requires holding a heavy lower link and moving its base portion in the vertical and horizontal directions for rather fine positioning. The above structure, which requires a lot of time and effort, leaves room for improvement.

Preferred embodiments of the present invention provide tractors each including a link mechanism capable of being easily attached to and detached from a body through a relatively simple operation.

A tractor according to a preferred embodiment of the present invention includes a body capable of autonomous travel, a link mechanism including at least one link including an end on a side of the body to be coupled to a work device, and a link attachment mechanism to attach the link mechanism to an end of the body in a front-back direction, the link attachment mechanism including a shaft with an axis in a left-right direction and supporting the end of the at least one link such that the at least one link is rotationally movable about the axis, at least one support provided on the body and supporting the shaft, and a fixing tool to disable or enable movement of the shaft in the left-right direction relative to the at least one support and to allow the shaft to be pulled out of and inserted into the at least one support in the left-right direction.

A tractor according to another preferred embodiment of the present invention includes a body, a link mechanism including at least one link including an end on a side of the body, and a link attachment mechanism to attach the link mechanism to an end of the body in the front-back direction, the link attachment mechanism including a shaft with an axis in a left-right direction and supporting the end of the at least one link such that the at least one link is rotationally movable about the axis, at least one support disposed on the body and supporting the shaft, and a fixing tool to disable or enable movement of the shaft in the left-right direction relative to the at least one support.

With this configuration, the fixing tool allows the shaft to be inserted into and pulled out of the support. The tractor is not configured such that an end of a link is positioned relative to a fixed shaft, but configured such that a shaft is inserted into and pulled out of a support. Thus, removing the link mechanism only requires causing the fixing tool to enable the movement and pulling out the shaft in the left-right direction. This is a simple operation involving only a short time period.

The tractor, which involves positioning the link relative to the support in attaching the link mechanism, does not require bringing an end of the link into the space between mutually facing ends of two shafts. This eliminates the need to adjust the left-right position of the end of the link. The tractor only requires adjusting the height position of the end of the link to the height of the support, thus allowing the shaft to be inserted easily into the end of the link.

The above configuration allows production of a tractor that only requires a relatively simple, short-time operation for attachment and detachment of a link mechanism, which involve attachment and detachment of a link to and from the body.

The tractor may preferably further include a hitch at the end of the body, wherein the at least one support supports the shaft such that the shaft is higher in position than a lower end of the hitch.

With the above configuration, the shaft for the link is higher in position than the hitch. Thus, selecting a lowest possible position for the shaft for the link leads to the link mechanism having a low upper end to allow the entire body to be stable.

In addition, the shaft is higher in position than the hitch, which tends to be disposed at a height position close to the road clearance, and does not protrude farther downward than the lower end of the hitch. The above configuration thus does not lower the road clearance, and also eliminates the risk of the shaft coming into contact with an object.

The tractor may preferably further include a hitch attachment on the body and supporting the hitch, wherein the at least one support includes a support on the hitch attachment.

With the above configuration, the support includes a hitch attachment, which is strong enough to bear the load of pulling a work device. This allows the support to have a strong structure.

The tractor may preferably include a plurality of supports on two side brackets at respective lateral portions of a transmission case of the tractor and on the hitch attachment, which protrudes backward from a lower portion of the transmission case, and the hitch is behind the hitch attachment and detachably attached to the hitch attachment.

The above configuration allows the shaft for the link to be supported by two side brackets at respective lateral portions of the transmission case and the hitch attachment, which protrudes backward from a lower portion of the transmission case. The above configuration thus allows the shaft for the link to be firmly supported by the transmission case and the hitch attachment.

The tractor may further include a left front wheel, a right front wheel, a left rear wheel, and a right rear wheel, the left rear wheel and the right rear wheel each include a hub with a depressed portion, and the shaft coincides with the depressed portion in a side view.

With the above configuration, the rear wheels each include a hub with a depressed portion, which is effectively usable as a space for the shaft to be inserted or pulled out and as a space for manual work. This further facilitates inserting and pulling out the shaft.

The at least one link may include a left link and a right link, and the tractor may further include a left stabilizer and a right stabilizer that are inward of the left link and the right link in the left-right direction relative to the body, and the shaft supports the left link, the right link, the left stabilizer, and the right stabilizer in such a manner that the left link, the right link, the left stabilizer, and the right stabilizer are each swingable in an up-down direction about the axis.

The above configuration allows a space for stabilizers to be provided easily as compared to the case of stabilizers being outward of links in the left-right direction. The tractor includes links wide apart from each other in the left-right direction. This allows the links to support a work device at respective positions widest possible apart from each other in the left-right direction to lift and lower the work device stably. If the tractor included stabilizers outward of the links in the left-right direction, the stabilizers would each need to be in a narrow gap between a link and a rear wheel laterally outward of the link. The stabilizers would, in such a case, be undesirably more likely to come into contact with an object. In view of that, the stabilizers are inward of the links in the left-right direction, eliminating the above risk.

The tractor may preferably further include a subframe attached to the body to couple, to a predetermined portion of the body, an implement body of an implement to be attached to the body, wherein the shaft does not coincide in a side view with the subframe as attached to the body.

With the above configuration, the shaft does not coincide in a side view with a subframe as attached to the body. The subframe thus does not hinder inserting or pulling out the shaft. The above configuration, in other words, eliminates the need to detach the subframe from the body, simplifying attachment and detachment of the implement.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a tractor in its entirety.

FIG. 2 is a plan view of a link mechanism as attached to a back portion of the body.

FIG. 3 is a side view of a link mechanism as attached to a back portion of the body.

FIG. 4 is a rear view of a link mechanism as attached to a back portion of the body.

FIG. 5 is a bottom view of a link mechanism as attached to a back portion of the body.

FIG. 6 is an exploded perspective view of a link attachment mechanism.

FIG. 7 is a side view of a tractor in its entirety as provided with a backhoe attached thereto.

### DETAILED DESCRIPTION OF THE PREFERRED EMBODIMENTS

The description below describes tractors according to preferred embodiments of the present invention with reference to drawings.

The description below of the preferred embodiments uses (i) terms such as “front” to refer to the front side of the direction in which the tractors according to preferred embodiments travel while performing work (indicated with arrow F in the drawings), (ii) terms such as “back” to refer to the back side of the same travel direction (indicated with arrow B in the drawings), (iii) terms such as “left” to refer to the left side relative to the front side (indicated with arrow L in the drawings), (iv) terms such as “right” to refer to the right side relative to the front side (indicated with arrow R in the drawings), (v) terms such as “upward” to refer to the upward direction (indicated with arrow U in the drawings), and (vi) terms such as “downward” to refer to the downward direction (indicated with arrow D in the drawings).

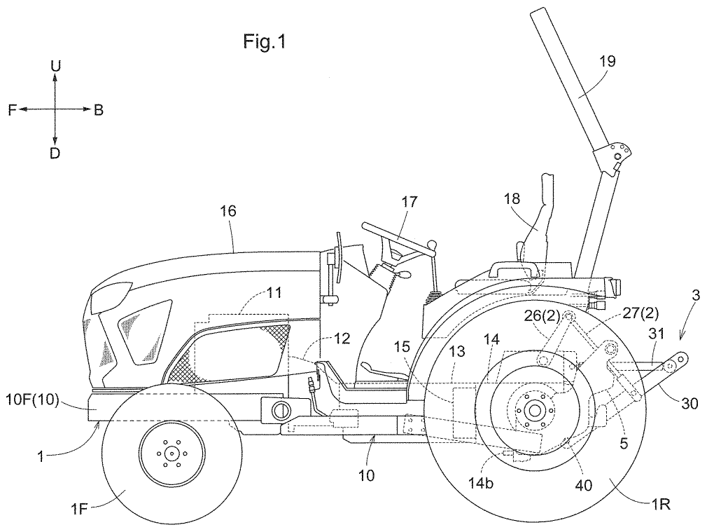

As illustrated in FIG. 1, the present preferred embodiment is an example tractor including a body 1 that includes a body frame 10, a motor section at a front half of the body frame 10, and a driver section at a back half of the body frame 10. The tractor includes front wheels 1F to the left and right of the motor section and rear wheels 1R to the left and right of the driver section. The front wheels 1F are drivable, and serve as steer wheels. The rear wheels 1R are drivable, and serve as non-steer, drive wheels. The tractor, in which the body 1 is provided with front wheels 1F and rear wheels 1R, is a four-wheel drive vehicle capable of autonomous travel.

The tractor includes (i) a water-cooling diesel engine (hereinafter referred to as “engine”) 11 coupled to a back portion of a front frame section 10F of the body frame 10, (ii) a clutch housing 12 coupled to a lower back portion of the engine 11, and (iii) a transmission case 14 coupled to a back portion of the clutch housing 12 via an intermediate frame section 13. The tractor thus has a monocoque structure over substantially the entire front-back dimension.

The motor section includes a hood 16 that defines an engine room containing components such as the engine 11. The driver section includes components such as a steering wheel for turning the front wheels 1F and a driver's seat 18. The tractor includes a ROPS 19 standing on a back portion of the body frame 10. The ROPS 19 is in the shape of an arch in a front view, and extends over a back portion of the driver's seat 18.

The tractor includes a hydraulic, continuously variable transmission device (hereinafter referred to as “HST”) 15. The HST 15 includes an input shaft (not shown in the drawings) coupled to a front portion of the transmission case 14 and configured to receive motive power from the engine through, for example, a main clutch (not shown in the drawings) in the clutch housing 12. The HST 15 also includes an output shaft (not shown in the drawings) configured to output motive power as travel power to a gear-type transmission device (not shown in the drawings) in the transmission case 14. The motive power from the gear-type transmission device is divided inside the transmission case 14 into motive power to drive the front wheels 1F and power to drive the rear wheels 1R.

The motive power to drive the front wheels 1F reaches the front wheels 1F through a front-wheel power transmission system (not shown in the drawings) extending from inside the transmission case 14 to the front wheels 1F. The motive power to drive the rear wheels 1R reaches the rear wheels 1R through a rear-wheel power transmission system (not shown in the drawings) extending from inside the transmission case 14 to the rear wheels 1R.

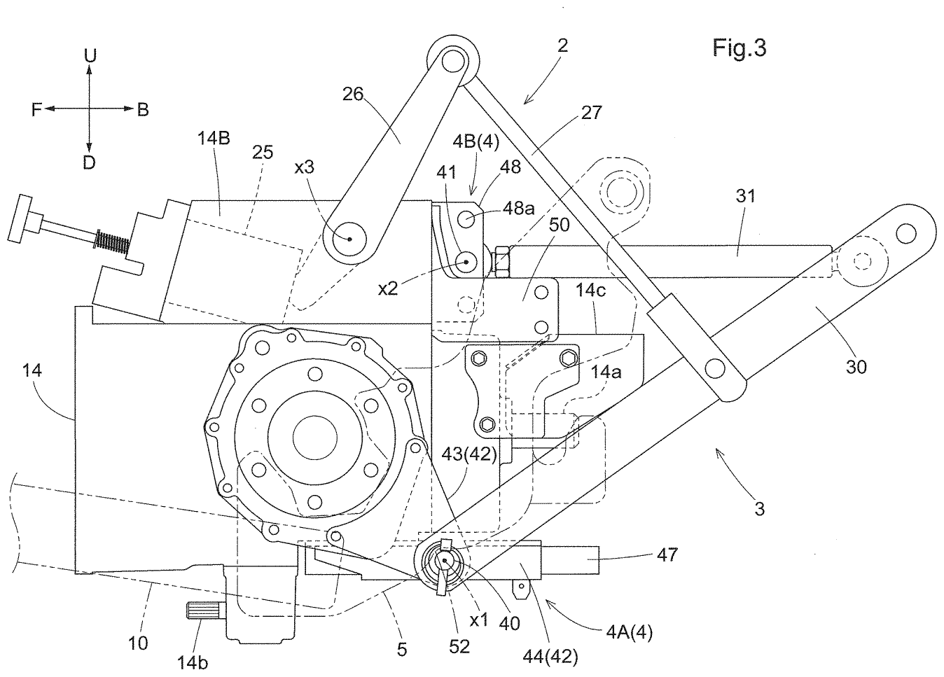

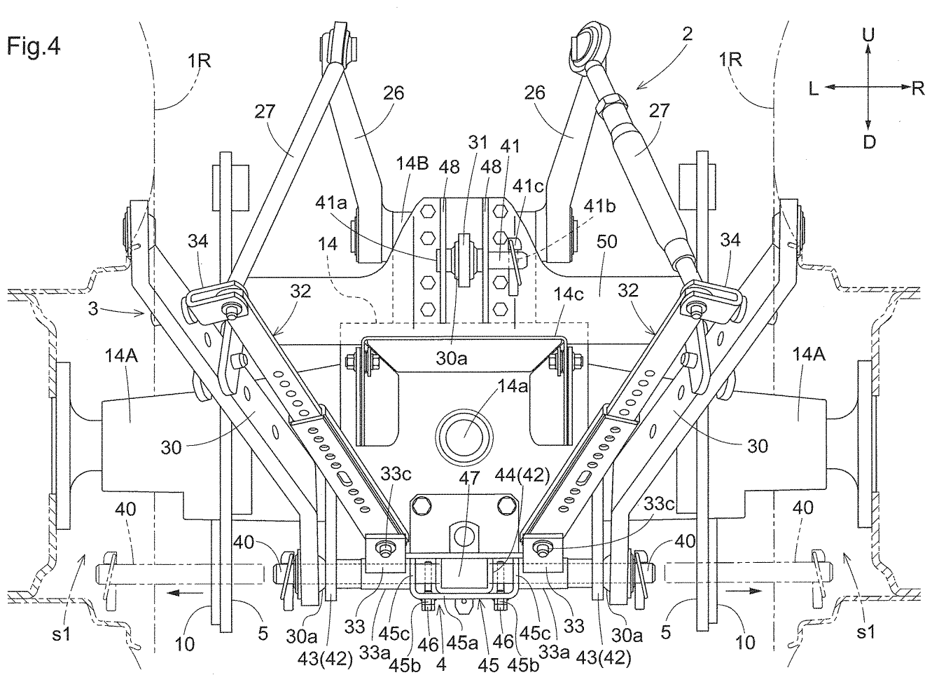

The HST 15 allocates a portion of the motive power that it receives at its input shaft to work as well. Specifically, the HST 15 outputs motive power to a work power transmission system (not shown in the drawings) in the transmission case 14. The work power transmission system varies the motive power as appropriate and divides the motive power into (i) motive power to be transmitted to a first motive power take-off shaft 14a disposed at a back end portion of the transmission case 14 and extending backward and (ii) motive power to be transmitted to a second motive power take-off shaft 14b disposed at a bottom portion of the transmission case 14 and extending forward. As illustrated in FIGS. 3 and 4, the transmission case 14 includes a PTO cover 14c covering the first motive power take-off shaft 14a from above and on the left and right sides.

The transmission case 14 includes at a left side portion a rear axle case 14A extending outward to the left side and at a right side portion another rear axle case 14A extending outward to the right side. The rear axle cases 14A and 14A contain a rear-wheel drive shaft (not shown in the drawings). The rear axle cases 14A and 14A are integral with the transmission case 14, but may alternatively be separate therefrom and configured to be coupled thereto.

As illustrated in FIGS. 1 to 4, the tractor includes at an upper portion of the transmission case 14 a lifting/lowering mechanism 2 configured to lift and lower a lifting/lowering link mechanism 3 (which is an example of the “link mechanism”) described later.

The transmission case 14 is provided with a cylinder block 14B attached to an upper portion thereof. The cylinder block 14B is provided with a pair of left and right lift arms 26, which are included in the lifting/lowering mechanism 2, and a lift cylinder 25 in the form of a single-acting hydraulic cylinder configured to swing the lift arms 26.

The lift arms 26 are disposed respectively on the left and right sides of the cylinder block 14B and swingable in the up-down direction about a lateral axis x3. The lift cylinder 25 is contained in the cylinder block 14B and configured to swing the respective base ends of the lift arms 26. The lift arms 26 have respective free ends each coupled to a lift rod 27, which is in turn coupled to a lower link 30 (which is an example of the “link”) of the lifting/lowering link mechanism 3. The lift arms 26 and the lower links 30 are interlocked with each other in such a manner that swinging the lift arms 26 in the up-down direction also swings the lower links 30 in the up-down direction.

The lifting/lowering link mechanism 3 includes the lower links 30 and a top link 31 each including a free end configured to be coupled to a work device as a coupling target such as a rotary tiller device (not shown in the drawings). Lifting and lowering the lift arms 26 also lifts and lowers the lower links 30 and the top link 31 and in turn lifts and lowers the work device coupled to the free ends.

As illustrated in FIGS. 1 to 4, the lifting/lowering link mechanism 3, which is at a back portion of the body 1, is a three-point link mechanism including a pair of left and right lower links 30 and a single top link 31 at a central position between the lower links 30 and 30 in a plan view.

The lower links 30 and the top link 31 are attached to the body 1 with use of a link attachment mechanism 4 described later.

The lower links 30 are each fitted around a lower shaft 40 with a spherical bearing 30a in-between. The lower shafts 40 (which is an example of the “shaft”) each provide an axis for up-down swing. The spherical bearing 30a is configured to receive external force in the radial direction and the thrust direction. The lower links 30 are each supported by the corresponding lower shaft 40 in such a manner that the lower link 30 is rotationally movable relative to the lower shaft 40 and that in a plan view, the lower link 30 and the axis x1 of the lower shaft 40 form an angle Θ1 changeable within a predetermined range.

The lifting/lowering link mechanism 3 includes two stabilizers 32 each at a position on the corresponding lower shaft 40 which positions is inward of the corresponding lower link 30 in the left-right direction of the body 1. The stabilizers 32 are configured to restrict left-right swing (yawing) of the lower links 30.

The stabilizers 32 each include a base end member 32A in the form of an angular pipe and a plate-shaped free end member 32B capable of being inserted into and pulled out of the base end member 32A. With this structure, sliding the free end member 32B relative to the base end member 32A in its lengthwise direction and fixing the free end member 32B at an appropriate position can adjust the length of the stabilizer 32. The base end member 32A and the free end member 32B each have a large number of coupling holes 32Aa, 32Ba arranged in the lengthwise direction. Selecting a pair of coupling holes 32Aa and 32Ba and inserting a coupling tool (not shown in the drawings) through the coupling holes 32Aa and 32Ba (for example, using a bolt and a nut) allows the stabilizer 32 to have a fixed length.

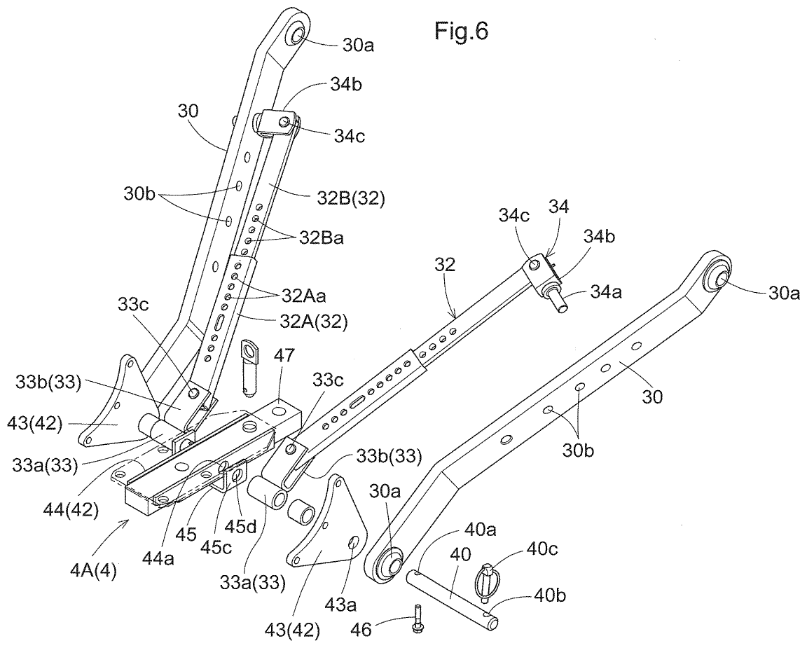

As illustrated in FIGS. 4 to 6, the lifting/lowering link mechanism 3 includes two attachment members 33 attached to the respective lower shafts 40. The attachment members 33 each include a cylinder 33a fitted around the corresponding lower shaft 40, a U-shaped coupling bracket 33b welded to the cylinder 33a, and a coupling pin 33c. Placing the base end of the base end member 32A inside the U-shaped coupling bracket 33b and inserting the coupling pin 33c through the coupling bracket 33b and the base end member 32A allows the stabilizer 32 to be coupled to the attachment member 33 in such a manner as to be swingable in the left-right direction.

The lifting/lowering link mechanism 3 includes two coupling fittings 34 each coupling the free end of the corresponding stabilizer 32 to a portion of the corresponding lower link 30 which portion is near its free end. The coupling fittings 34 each include a lock pin 34a, a U-shaped bracket 34b, and a coupling pin 34c. The lock pin 34a is welded to the U-shaped bracket 34b, and is capable of being inserted into and pulled out of a coupling hole 30b in the corresponding lower link 30. The U-shaped bracket 34b is coupled to the free end member 32B with use of the coupling pin 34c.

The stabilizers 32 thus each have a free end coupled to the corresponding lower link 30 with use of a coupling fitting 34. Similarly to the lower links 30, the stabilizers 32 are each supported by the corresponding lower shaft 40 in such a manner that the stabilizer 32 is rotationally movable relative to the lower shaft 40 and that in a plan view, the stabilizer 32 and the axis x1 of the lower shaft 40 form an angle Θ2 changeable about the coupling pin 33c.

The top link 31 has a base end and a free end. The base end is pivotally supported by a back end portion of the body 1 which back end portion is higher in position than that back end portion of the body 1 by which the lower links 30 are supported. The free end is configured to be coupled to a work device as a coupling target such as a rotary tiller device (not shown in the drawings) as with the lower links 30.

As illustrated in FIG. 3, the top link 31 is swingable in the up-down direction about an upper shaft 41 disposed at a position higher than the respective positions of the lower shafts 40, about which the respective lower links and 30 are swingable. The top link 31 has a front-back dimension a little smaller than the front-back dimension of the lower links 30 and 30.

The top link 31 is attached to the upper shaft 41 also with a spherical bearing 30a in-between that is configured to receive external force in the radial direction and the thrust direction. The top link 31 is thereby supported by the upper shaft 41 in such a manner that the top link 31 is rotationally movable relative to the upper shaft 41 and that in a plan view, the top link 31 and the axis x2 of the upper shaft 41 form an angle changeable within a predetermined range.

The lifting/lowering link mechanism 3 is coupled to a back portion of the body 1 via a link attachment mechanism 4 configured as below.

As illustrated in FIGS. 3 to 6, the link attachment mechanism 4 includes a lower attachment mechanism 4A for the lower links 30 to be attached to the body 1 and an upper attachment mechanism 4B for the top link 31 to be attached to the body 1.

The lower attachment mechanism 4A includes a pair of left and right lower shafts 40 and 40, a plurality of supports 42, and two fixing tools 46. The lower shafts 40 and 40 each support that end of the corresponding lower link 30 which is on the side of the body 1 and allow the lower link 30 to move rotationally about the left-right axis x1. The supports 42 allow the lower shafts 40 to be supported by the body 1. The fixing tools 46 each disable or enable left-right movement of the corresponding lower shaft 40 relative to the supports 42.

The supports 42 are on (i) two side brackets 43 disposed at respective lateral portions of the transmission case 14 and on (ii) a hitch attachment member 44 protruding backward from a lower portion of the transmission case 14. The side brackets 43 each have an insertion hole 43a for the corresponding lower shaft 40. The hitch attachment member 44 similarly has two insertion holes 44a in each of which an end of the corresponding lower shaft 40 is insertable. With each lower shaft 40 through the insertion holes 43a and 44a, the respective base ends of the corresponding lower link 30 and stabilizer 32 are supported by the lower shaft 40 and coupled to the body 1.

The fixing tools 46 are each in the form of a check bolt insertable in a check hole 40a in that end of the corresponding lower shaft 40 which is inward of the body 1.

As illustrated in FIGS. 4 to 6, the lower attachment mechanism 4A includes a fixation bracket 45 with an upward channel. The fixation bracket 45 has a bottom plate 45a fixed to the bottom surface of the hitch attachment member 44. The fixation bracket 45 is wider (that is, larger in the left-right dimension) than the hitch attachment member 44. The fixation bracket 45 has two insertion holes (not shown in the drawings) for the respective fixing tools 46 each in a portion of the bottom plate 45a which portion protrudes laterally from the hitch attachment member 44. The fixation bracket 45 is provided with two fixing nuts 45b each welded to the bottom plate 45a and configured to threadedly receive the corresponding fixing tool 46 as inserted in the corresponding insertion hole.

Screwing each fixing tool 46 into the corresponding fixing nut 45b straight through the bottom plate 45a of the fixation bracket 45 and inserting the fixing tool 46 into the check hole 40a in the corresponding lower shaft 40 can prevent left-right movement of the lower shaft 40. Pulling the fixing tool 46 out of the check hole 40a allows left-right movement of the lower shaft 40 to allow the lower shaft 40 to be pulled out laterally.

The fixation bracket 45 includes two standing side plates 45c and 45c disposed at respective lateral sides, that is, standing at opposite ends of the bottom plate 45a. The standing side plates 45c and 45c have respective through holes 45d and 45d in each of which to receive the corresponding lower shaft 40 as inserted.

The lower shafts 40 are thus each supported at three positions: the insertion hole 43a in the corresponding side bracket 43, the corresponding insertion hole 44a in the hitch attachment member 44, and the through hole 45d in the corresponding standing side plate 45c.

The lower shafts 40 each have a pin hole 40b in a portion laterally outward of the corresponding lower link 30, and are each provided with a retaining pin 40c configured to be inserted into and pulled out of the corresponding pin hole 40b. The pin hole 40b and the retaining pin 40c serve to prevent the corresponding lower link 30 from being accidentally removed from the corresponding lower shaft 40.

The hitch attachment member 44 is provided with a hitch 47 disposed at an end of the body 1 in the front-back direction and configured to pull a work device (not shown in the drawings) or the like. The hitch 47 is supported by the hitch attachment member 44 in such a manner as to be (i) slidable relative to the hitch attachment member 44 in the front-back direction to change its attachment position and (ii) detachable from the hitch attachment member 44.

The side brackets 43 and the hitch attachment member 44, on which the supports 42 are disposed, are positioned so that the lower shafts 40 are higher in position than the lower end of the hitch 47. Designing each lower shaft 40 to have a height position in relation to the height of the lower end of the hitch 47 as such results in the lower shaft 40 having a height position that is close to the road clearance of the body 1 and that is higher than the sturdy hitch 47. This likely prevents the lower shafts 40 from coming into contact with an object.

The upper attachment mechanism 4B, which is for the top link 31 to be attached to the body 1, includes an upper shaft 41 and a pair of left and right attachment brackets 48 and 48. The upper shaft 41 supports that end of the top link 31 which is on the side of the body 1 and allows the top link to move rotationally about the left-right axis x2. The attachment brackets 48 and 48 each serve as a support that allows the upper shaft 41 to be supported by the body 1.

The attachment brackets 48 and 48 are each welded to the back surface of a subframe support member 50 attached to the back surface of the cylinder block 14B, which is fixed to an upper portion of the transmission case 14.

The subframe support member 50 couples a pair of left and right subframes 5 and 5 described later. The subframe support member 50 has (i) an intermediate portion in the left-right direction which intermediate portion is attached to the back surface of the cylinder block 14B and (ii) opposite lateral ends coupled to respective upper portions of the subframes 5 and 5.

The attachment brackets 48 each have three attachment holes 48a arranged in the up-down direction. The upper shaft 41 is inserted through one of the three attachment holes 48a in each attachment bracket 48 to be supported by the attachment brackets 48.

The upper shaft 41 has a flange-shaped head 41a at a first end, and also has a retaining hole 41b in a second end as well as a retaining pin 41c. Removing the retaining pin 41c allows the upper shaft 41 to be pulled out and the top link 31 to be removed.

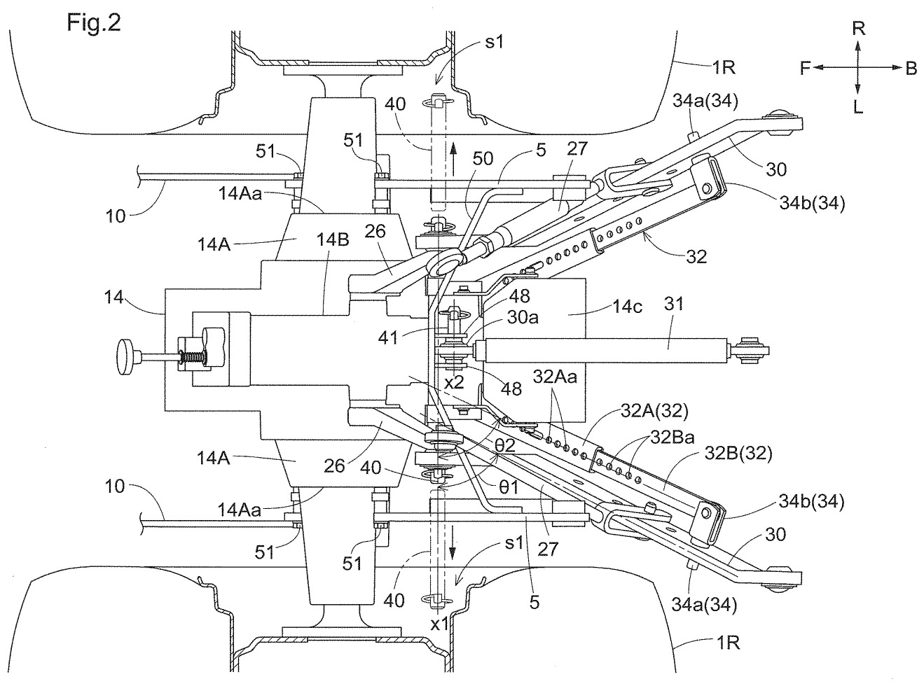

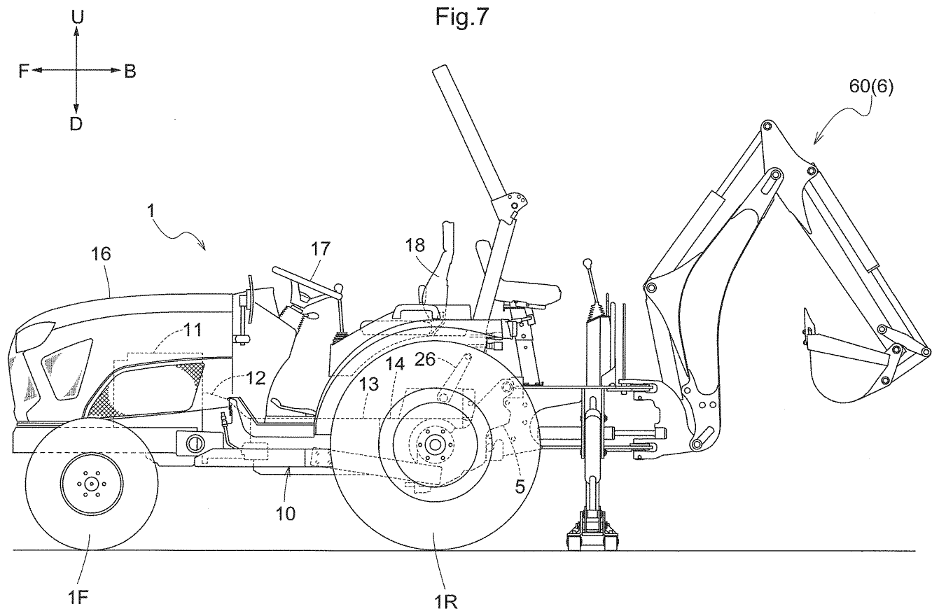

As illustrated in FIGS. 2 to 4, the tractor includes subframes 5 each at a position laterally outward of the laterally outward end of the corresponding lower shaft 40 as inserted through the supports 42. The subframes 5 allow a backhoe to be fixedly attached thereto, the backhoe being an implement 6 (see FIG. 7) attachable to the body 1 for use.

The subframes 5 are for use to couple the backhoe to the tractor, meaning that the subframes 5 technically belong to the implement 6 in terms of the function. However, the description of the present preferred embodiment uses the term “implement body 60” to refer to that portion of the implement 6 which is attachable to and detachable from the tractor and which performs work and the term “subframes 5” to refer to that portion which is for use to attach the implement body 60 to the tractor.

The subframes 5 are each in contact with a step 14Aa in the corresponding rear axle case 14A from laterally outward as indicated with a double-dashed chain line in FIG. 3. The rear axle cases 14A and 14A extend laterally outward from the respective lateral sides of the transmission case 14. The step 14Aa is at a portion of the corresponding rear axle case 14A which portion is partway in the left-right direction. The subframes 5 are each fixedly coupled to the corresponding rear axle case 14A with use of fixation bolts 51. The subframes 5 each have a lower end portion fixedly coupled to the body frame 10, which extends under the rear axle cases 14A and 14A. The lower end portion may be, for example, welded or riveted to the body frame 10, or even fixed thereto detachably with use of a bolt and a nut.

The subframes 5 are thus fixed to the body frame 10 and coupled to the respective rear axle cases 14A and 14A. As described above, the subframes 5 have respective upper portions fixedly coupled to the respective lateral ends of the subframe support member 50, which has an intermediate portion in the left-right direction which intermediate portion is attached to the back surface of the cylinder block 14B.

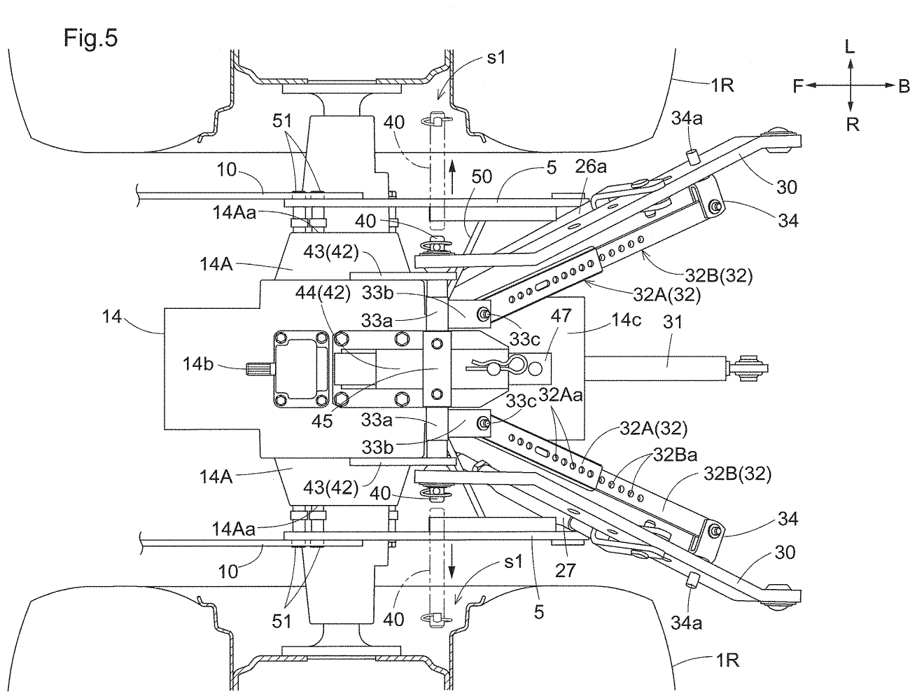

As illustrated in FIGS. 4 and 5, the subframes 5 are each at such a position in the left-right direction that the subframe 5 is apart from the corresponding side bracket 43, which is attached to a lateral side surface of the transmission case 14, in the left-right direction by a distance smaller than the left-and-right dimension of the corresponding lower shaft 40. This means that pulling a lower shaft 40 entirely out of the supports 42 requires the lower shaft 40 to pass by a portion of the corresponding subframe 5 in the left-right direction.

Thus, as illustrated in FIG. 3, the subframes 5 each have a depressed portion 52 at a position by which the corresponding lower shaft 40 passes when pulled out. The depressed portion 52 of each subframe 5 prevents the corresponding lower shaft 40 from coinciding with the subframe in a side view. The subframes 5 thus do not each prevent the corresponding lower shaft 40 from being moved in such a direction as to be pulled out of the supports 42.

The lower shafts 40 are, as attached to the supports 42, each positioned to coincide with a depressed portion s1 in the hub of the corresponding rear wheel 1R in a side view.

Each depressed portion s1 allows the corresponding lower shaft 40 to be laterally pulled out farther by an amount corresponding to the left-and-right dimension of the space defined by the depressed portion s1. This allows each lower shaft 40 to be pulled out of the supports 42 without the need to remove the corresponding rear wheel 1R.

The tractor as the present preferred embodiment is configured as described above such that pulling the lower shafts 40 out of the supports 42 and the upper shaft 41 out of the attachment brackets 48 allows the lower links 30, the stabilizers 32, and the top link 31 to be removed from the body 1.

With the lower links 30, the stabilizers 32, and the top link 31 removed from the body 1, attaching a backhoe as a portion of the implement 6 to the subframes 5 as illustrated in FIG. 7 allows the tractor to be ready for backhoe work.

The driver's seat 18 mentioned above is capable of switching its direction between forward and backward (not detailed herein). This allows the driver to sit on the driver's seat 18 facing backward to operate a device for operation of the backhoe during backhoe work.

With the backhoe as the implement body 60 of the implement 6 removed, the subframes 5 remain on the body 1. The subframes 5 do not prevent the operation of the lower links 30, the stabilizers 32, or the top link 31.

The subframes 5 do not hinder pulling the lower shafts 40 out of the supports 42 or the upper shaft 41 out of the attachment brackets 48. This allows the subframes 5 to remain attached to the body 1. The subframes 5 remaining constantly on the body 1 as such eliminates the need to attach and detach the subframes 5 when attaching and detaching the implement body 60 to simplify the attachment and detachment of the backhoe as a portion of the implement 6.

The subframes 5, which remain constantly on the body 1, protrude farther backward than the first motive power take-off shaft 14a as illustrated in FIG. 3, the first motive power take-off shaft 14a being disposed at a back end portion of the transmission case 14 and extending backward. The protruding end of each subframe 5 is close in position to the backwardly protruding end of the PTO cover 14c. The subframes 5 thus serve together with the PTO cover 14c to reduce the risk of the first motive power take-off shaft 14a coming into contact with an object.

The preferred embodiments described above are examples such that the lifting/lowering link mechanism 3 is a three-point link mechanism including a top link 31 and a pair of left and right lower links 30. The present invention is, however, not necessarily structured as such, and may alternatively include, for example, a two-point link mechanism including a pair of left and right link members as lower links (not illustrated in the drawings).

Such a preferred embodiment may be otherwise configured similarly to the preferred embodiments described above.

The preferred embodiments described above are examples such that the lifting/lowering link mechanism 3 and the link attachment mechanism 4 are at a back end portion of the body 1. The present invention is, however, not necessarily structured as such, and may alternatively be configured, for instance, such that the lifting/lowering link mechanism 3 and the link attachment mechanism 4 are at a front end portion of the body 1 (not illustrated in the drawings).

Such a preferred embodiment may be otherwise configured similarly to the preferred embodiments described above.

The preferred embodiments described above are, as examples, a tractor including front wheels 1F and rear wheels 1R. The present invention is, however, not necessarily structured as such, and may alternatively include, for example, crawler travel devices (not illustrated in the drawings) instead of either the front wheels 1F or the rear wheels 1R. In this case, the depressed portions s1 for the respective lower shafts 40 to be pulled out may be in the respective front wheels 1F, rear wheels 1R, or crawler travel devices. In the case where the tractor includes as its travel devices only crawler traveling devices instead of the front wheels 1F and the rear wheels 1R, the depressed portions s1 may each be outside the area defined by the crawler belt wound around on the corresponding crawler travel device.

Such a preferred embodiment may be otherwise configured similarly to the preferred embodiments described above.

The preferred embodiments described above are examples such that the lower shafts 40 and 40 are capable of being pulled out laterally. The present invention is, however, not necessarily structured as such, and may alternatively include, for example, a single, longer lower shaft 40 capable of being inserted through both the lower links 30 and pulled out to the left or right if the tractor is configured to support such a lower shaft 40 at such a position as not to coincide with, for example, the subframes 5 or the rear wheels 1R.

Such a preferred embodiment may be otherwise configured similarly to the preferred embodiments described above.

The preferred embodiments described above are examples including stabilizers 32 to restrict the respective orientations of the lower links 30. The present invention is, however, not necessarily structured as such, and may alternatively include, for example, check chains (not illustrated in the drawings) instead of the stabilizers 32.

Such a preferred embodiment may be otherwise configured similarly to the preferred embodiments described above.

The preferred embodiments described above are configured such that the supports 42 are on (i) two side brackets 43 disposed at respective lateral portions of the transmission case 14 and on (ii) a hitch attachment member 44 protruding backward from a lower portion of the transmission case 14. The present invention is, however, not necessarily structured as such, and may alternatively include, for example, two side brackets 43 on the rear axle case 14A, apart from the lateral portions of the transmission case 14, or even three or more side brackets 43 (not illustrated in the drawings).

Preferred embodiments of the present invention may further alternatively be configured as appropriate, for instance, such that the side brackets 43 and the hitch attachment member 44 are integral with each other or that the hitch attachment member 44 is replaced with a completely different support member.

Such a preferred embodiment may be otherwise configured similarly to the preferred embodiments described above.

The preferred embodiments described above are examples such that those elements which prevent the lower shafts 40 from being pulled out are each in the form of a check bolt insertable in a check hole 40a in that end of the corresponding lower shaft 40 which is inward of the body 1. The present invention is, however, not necessarily structured as such, and may include alternative elements as appropriate such as (i) elements each configured to hold the corresponding lower shaft 40 from radially outward or (ii) stoppers each disposed at the outlet from which the corresponding lower shaft 40 is pulled out.

Such a preferred embodiment may be otherwise configured similarly to the preferred embodiments described above.

The preferred embodiments described above are examples such that the tractor is provided with a backhoe as a portion of the implement 6 coupled thereto. The tractor is, however, not necessarily provided with a backhoe, and may alternatively be provided with, for example, a work machine structured not to be coupled to a three-point link mechanism, such as a scraper. The tractor allows the three-point link mechanism to be removed easily in such a case.

Such a preferred embodiment may be otherwise configured similarly to the preferred embodiments described above.

The preferred embodiments described above are examples such that the subframes 5 are constantly attached to the body 1. The subframes 5 may, however, alternatively be each entirely or partially detachable where necessary.

Such a preferred embodiment may be otherwise configured similarly to the preferred embodiments described above.

The tractors according to preferred embodiments of the present invention may include a shaft capable of being inserted and pulled out to allow a link mechanism to be attached and detached easily. Preferred embodiments of the present invention are applicable not only to a tractor provided with a ROPS at the driver section, but also to a tractor provided with a driver cabin or a canopy as well as to a tractor not provided with a component such as a ROPS, a driver cabin, or a canopy.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A tractor, comprising:
a body capable of autonomous travel;
a link mechanism including at least one link including an end on a side of the body to be coupled to a work device;
and a link attachment mechanism to attach the link mechanism to an end of the body in a front-back direction;
the link attachment mechanism including:
a shaft with an axis in a left-right direction and supporting the end of the at least one link such that the at least one link is rotationally movable about the axis;
at least one support provided on the body and supporting the shaft; and
a fixing tool to disable or enable movement of the shaft in the left-right direction relative to the at least one support and to allow the shaft to be pulled out of and inserted into the at least one support in the left-right direction.

2. The tractor according to claim 1, further comprising:
a hitch at the end of the body; wherein
the at least one support supports the shaft such that the shaft is higher in position than a lower end of the hitch.

3. The tractor according to claim 2, further comprising:
a hitch attachment provided on the body and supporting the hitch; wherein
the at least one support includes a support on the hitch attachment.

4. The tractor according to claim 3, wherein
the at least one support includes a plurality of supports on two side brackets at respective lateral portions of a transmission case of the tractor and on the hitch attachment,
which protrudes backward from a lower portion of the transmission case; and
the hitch is behind the hitch attachment and detachably attached to the hitch attachment.

5. The tractor according to claim 1, wherein
the body is provided with a left front wheel, a right front wheel, a left rear wheel, and a right rear wheel;
the left rear wheel and the right rear wheel each include a hub with a depressed portion; and
the shaft coincides with the depressed portion in a side view.

6. The tractor according to claim 1, wherein
the at least one link includes a left link and a right link;
the tractor further comprises a left stabilizer and a right stabilizer that are inward of the left link and the right link in the left-right direction relative to the body; and
the shaft supports the left link, the right link, the left stabilizer, and the right stabilizer in such a manner that the left link, the right link, the left stabilizer, and the right stabilizer are each swingable in an up-down direction about the axis.

7. The tractor according to claim 1, further comprising:
an implement attachable to the body and including an implement body and a subframe to couple the implement body to a predetermined portion of the body; wherein
the shaft does not coincide in a side view with the subframe as attached to the body.
